(19) United States
(12) Patent Application Publication
(10) Pub. No.: US 2009/0106060 A1
(43) Pub. Date: Apr. 23, 2009

(54) METHOD AND APPARATUS FOR DETERMINING CAPITAL INVESTMENT, EMPLOYMENT CREATION AND GEOGRAPHIC LOCATION OF GREENFIELD INVESTMENT PROJECTS

(75) Inventor: Henry Bernard LOEWENDAHL, Twickenham (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: OCO CONSULTING LTD., Belfast (IE)

(21) Appl. No.: 11/875,155

(22) Filed: Oct. 19, 2007

(51) Int. Cl. G06Q 40/00

(52) U.S. Cl. 705/7; 705/10; 705/35

(57) ABSTRACT

A Project Size Estimation and Triple Weighted Location Assessment Model to estimate the capital investment, employment creation and to determine the highest quality geographic location for a Greenfield investment project, based on algorithms that firstly calculate and apply capital and employment intensity and average project size ratios to estimate capital investment and employment creation for the project and secondly apply a triple weighted quality assessment model to calculate the quality competitiveness of locations for the investment project.

### TECHNICAL FIELD

The present invention relates to calculating at least one of the capital investment, employment creation and geographic location of Greenfield investment projects at the individual project level, which can be aggregated to produce results at the worldwide level. The present invention was specifically designed for Foreign Direct Investment projects, but can equally be applied to Domestic (National) Greenfield investment projects. A Greenfield investment project is defined as a new physical operation established by a company to provide products and/or services. It is a Foreign Direct Investment project if the operation is established in an overseas country outside of the country where the ultimate headquarters of the company is based.

### BACKGROUND

Greenfield investment by private sector enterprises is the main source of capital investment and employment creation in all developed market economies. The size of this investment is a major determinant of economic growth and employment. The decision of enterprises on where to locate their Greenfield investment project(s) determines which country, region and city will benefit from economic growth and employment creation. For the efficient operation of markets and for Government policy it is of global importance to be able to quantify the scale of Greenfield investment and to determine the optimal location for this investment.

The only reliable source of data on the capital investment associated with Foreign Direct Investment, is that available in the National Balance of Payments Accounts of Governments, the most established worldwide source of which is the World Investment Report, published annually by the United Nations Conference on Trade and Development (UNCTAD). The Balance of Payments data is highly aggregated, and includes all types of cross-border direct investment capital flows, including capital flows related to Mergers & Acquisitions. The Greenfield investment component cannot be separated from the data. There are many other drawbacks with the official data, several of which include: it is not possible to breakdown the data to the individual project or company level; it is based on the capital flows which cross-borders—not the total amount a company is investing, regardless of where the capital is sourced; and data cannot be broken down for specific sectors, sub-sectors, business activities or at the sub-national level. Similar issues are presented the National Accounts of Governments, which provide aggregated data on Domestic Investment (Gross Fixed Capital Formation).

Despite the global importance of Foreign Direct Investment, as well as for capital investment, there is no known estimate for the employment created by Greenfield Foreign Direct Investment. The only data available is that related to employment in the subsidiaries of multinational companies, much of which can come about through Mergers & Acquisitions, rather than Greenfield investment, and which cannot be disaggregated down to the project or company level.

While most major accountancy companies have models to assess the economic impact of investment and to calculate the optimal geographic location in terms of operating costs and financial return on investment, there is no quantitative model to estimate the capital investment and employment creation of Greenfield investment and to assess and determine the highest quality location(s) for Greenfield investment projects. The location decision of companies to determine in which location to establish a Greenfield investment project has hitherto been based on a cost and financial models and a subjective, qualitative approach to assessing the quality of different location options, making use of generic country competitiveness indexes (e.g. Institute of Management Development's World Competitiveness Report and the World Economic Forum's Global Competitiveness Report) and data comparisons.

There is therefore a need for a model to firstly estimate the capital investment and employment creation of Greenfield (Foreign Direct) Investment projects and secondly to assess which geographic locations offer the highest quality for Greenfield investment project(s).

### SUMMARY

According to a first aspect of the present invention there is provided a method of estimating the size of a Greenfield investment project, where size is at least one of capital investment and employment creation, comprising accessing data from a Project Size Estimation model database which specifies a set of ratios relating to historical capital investment intensities, job creation intensities and project size for each of a plurality of combinations of Country, Activity and Sector, and using the data to estimate the size of the Greenfield investment project.

The method may comprise outputting the estimated size. The step of outputting may comprise at least one of displaying and printing.

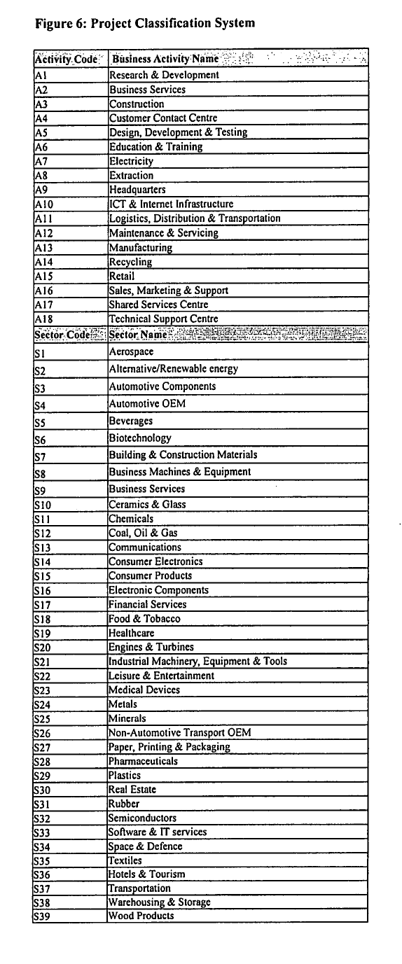

The Sectors and Activities may comprise at least some of those shown in FIG. 6, preferably all of those shown in FIG. 6.

Ratios for capital investment intensities, job intensities, capital investment and job creation may be specified in the database for each combination of Country, Activity and Sector.

The ratios may be determined subject to minimum sample size requirements and adjustments to remove outliers.

The ratios may comprise at least some of those as set out in paragraph [0030], preferably all of those set out in paragraph [0030].

The method may comprise, where the employment creation of the Greenfield investment project is known but the capital investment is not, using a selected one of the algorithms set out in paragraph [0032] to determine the capital investment.

The method may comprise, where the capital investment of the Greenfield investment project is known but the employment creation is not, using a selected one of the algorithms set out in paragraph [0033] to determine the employment creation.

The method may comprise, where the capital investment and employment creation of the Greenfield investment project are not known, using a selected one of the algorithms set out in paragraph [0034] to determine the capital investment and employment creation.

According to a second aspect of the present invention there is provided a method of estimating the highest quality geographic location for a Greenfield investment project, comprising accessing data from a Weighted Location Assessment Model database which specifies a plurality of weights associated with respective influence items arranged in three predetermined tiers: (1) a set of Location Criteria; (2) a set of Location Factors within each Location Criterion; and (3) a set of Data Points within each Location Criterion; each weight indicating the relative importance of its associated influence item in investment decision making, and using the data to calculate an overall Quality Competitiveness of various locations for the Greenfield investment project for use in estimating the highest quality location for the Greenfield investment project.

The method may comprise presenting the results in graphical form. The calculation may be based on a model that considers how each location deviates from the average of all locations.

The weights in each set may sum to a predetermined number. The average Quality Competitiveness of all locations may be arranged to be a predetermined number.

The predetermined number may be 100.

The results may show, for each location, the overall Quality Competitiveness with a breakdown by Location Criteria.

The results may show, for each location, a breakdown for at least one Location Factor.

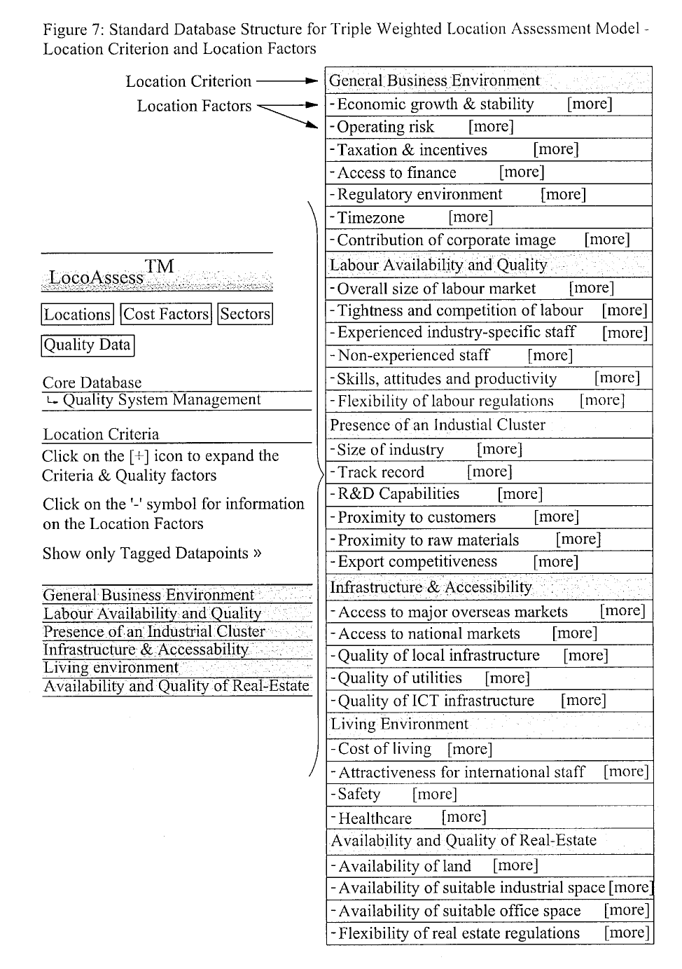

The Location Criteria and Location Factors may comprise at least some of those as shown in FIG. 7, preferably all of those shown in FIG. 7.

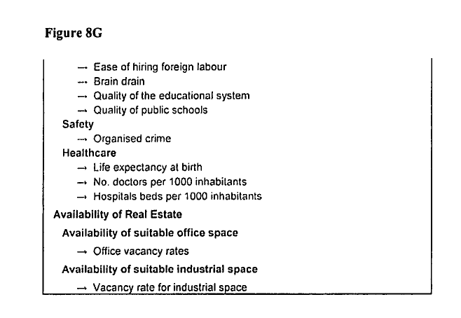

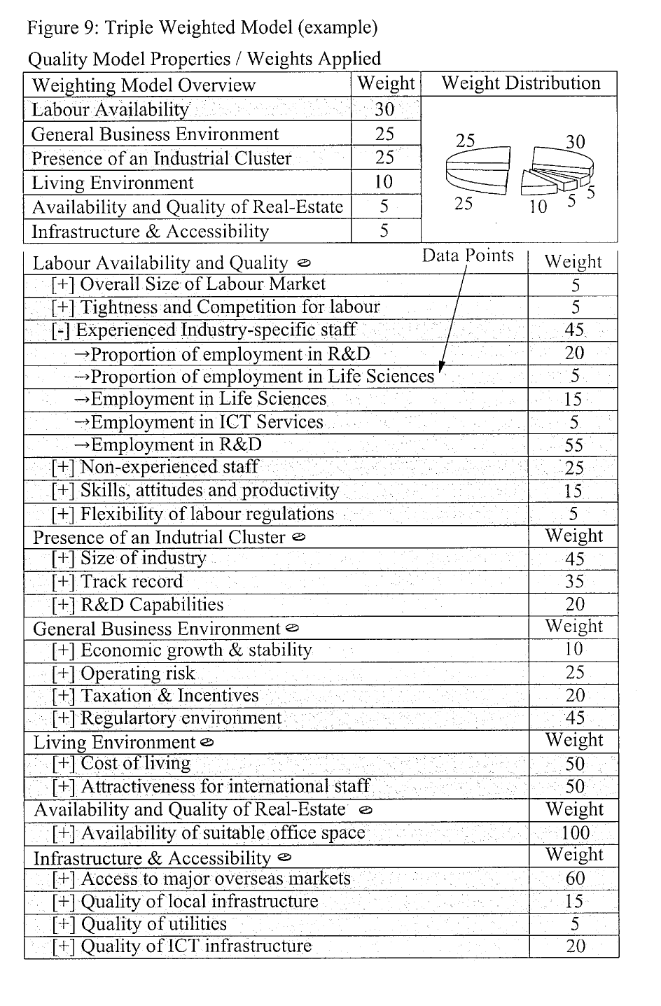

The Data Points may be of a type shown in FIG. 9 for one Location Factor.

The method may comprise calculating the deviation from the average of all locations for each Data Point.

The method may comprise multiplying the deviation from the average by the weights assigned to each Data Point to produce a Weighted Quality Score of each Location for each Data Point.

The method may comprise multiplying the sum of weighted quality scores for all Data Points within each Location Factor by the weights assigned to each Location Factor to produce a Weighted Quality Score of each Location for each Location Factor.

The method may comprise multiplying the sum of weighted quality scores for all Location Factors within each Location Criteria by the weights assigned to each Location Criteria to produce a Weighted Quality Score of each Location for each Location Criteria.

The sum of weighted quality scores for each location criteria may produce a single Quality Competitiveness Score for each location.

The score may be 100% aligned to the location requirements of the Greenfield investment project, and calculated quantitatively based on empirical data (Data Points).

The calculation may comprise performing the steps as set out in paragraph [0039].

The results may be presented graphically in a form substantially as shown in FIG. 9.

According to a third aspect of the present invention there is provided an apparatus comprising means for performing a method according to the first aspect of the present invention.

According to a fourth aspect of the present invention there is provided an apparatus comprising means for performing a method according to the second aspect of the present invention.

According to a fifth aspect of the present invention there is provided a program for controlling an apparatus to perform a method according to the first or second aspect of the present invention.

The program may be carried on a carrier medium.

The carrier medium may be a storage medium or a transmission medium.

According to another aspect of the present invention there is provided an apparatus programmed by a program according to the fifth aspect of the present invention.

According to another aspect of the present invention there is provided a storage medium containing a program according to the fifth aspect of the present invention.

In accordance with an embodiment of the first aspect of the present invention there is provided a method of estimating the capital investment and employment creation of Greenfield (Foreign Direct) Investment projects, the method comprising:
Identifying Greenfield investment projects where data on capital investment and employment creation is publicly available, and classifying these projects by Sector, Activity, and Country;
Applying algorithms to the data mentioned in paragraph [0008] to identify, for all combinations of Sector, Activity and Country, 24 ratios of capital and employment intensity and average capital investment and employment creation values, resulting in a look-up table with a total of 134,784 possible ratios/values (see paragraph [0030] for the 24 ratios);
Identifying Greenfield investment projects where data on capital investment and/or employment creation is not known, and classifying these projects by Sector, Activity, and Country;
Estimating the capital investment and employment creation for individual investment projects i.e. filling the gaps in paragraph [0010] based on the ratios and values generated in paragraph [0009], with one of 24 algorithms being applied to each project (see paragraphs [0032] to [0034]); and
Combining the actual data on capital investment and employment creation in paragraph [0008] with the estimated data in paragraph [0011] to produce aggregate data on capital investment and employment creation by Sector, Activity and Country.

This method has the advantage of estimating capital investment and employment creation as accurately as possible. The Sector, Activity and Country are shown by testing to have a major influence on the size of investment projects, with the most accurate estimates achieved when it is possible to apply the algorithm for a specific Country, Activity and Sector combination. On a project level, an R Squared of over 70% can be achieved for estimating capital investment and employment using the more accurate algorithms and on an aggregate level a deviation of less than 10% of estimated versus actual capital investment and employment can be achieved.

A software programme in Adobe Coldfusion using Macromedia Dreamweaver has been developed by the present applicant that applies the Project Size Estimation model to the applicant's database of over 50,000 Foreign Direct Investment and Inter-State USA Greenfield Investment Projects (see www.ocomonitor.com). As this database grows (1,000 new projects are added every month) the capital investment and employment estimates becomes more accurate over time.

In accordance with an embodiment of the second aspect of the present invention there is provided a method of assessing and identifying the highest quality geographic location for a Greenfield (Foreign Direct) Investment projects, the method comprising:
Add weights to the “Triple Weighted Location Assessment Model” for a given Greenfield investment project or Sector/Activity combination, which involves applying a weight to each Location Criteria, to each Location Factor and to each Data-Point used for location assessment, according to its importance in the investment decision making. The sum of weights always adds up to 100;
Apply the Triple Weighted Location Assessment Model to calculate the overall quality competitiveness of each location for the specific Greenfield investment project or Sector/Activity combination.

This method has the advantage of calculating a quantitative value for the competitiveness of locations for an individual Greenfield investment project, 100% customised to the location selection requirements of that project.

The method also has the advantage of being able to rank the competitiveness of locations for specific combinations of Sector and Activity, which is a fundamental innovation compared to existing competitiveness indexes, which are all generic and are not specific to any Sector or Activity.

The Triple Weighted Location Assessment Model can be applied to any geographic level (e.g. countries, regions, cities) and furthermore not only provides a quantitative approach to evaluating the competitiveness of locations for Greenfield investment, but also, through the design of the Triple Weighted Model, will show the relative strengths and weaknesses of each location for each location Criterion, location Factor and individual Data-Point. This provides for instant identification of the critical strengths and weaknesses of each location aligned to the specific requirements of a Greenfield investment project.

A software programme in Adobe Coldfusion using Macromedia Dreamweaver has been developed by the present applicant that applies the model to the applicant's online location benchmarking tool. See Appendix for extracts of the software code for the Triple Weighted Location Assessment Model (also see www.ocoassess.com for the product to be launched from the Model).

### HOW TO PUT THE INVENTION INTO EFFECT

Some preferred embodiments of the invention will now be described by way of example only and with reference to the accompanying drawings, in which:

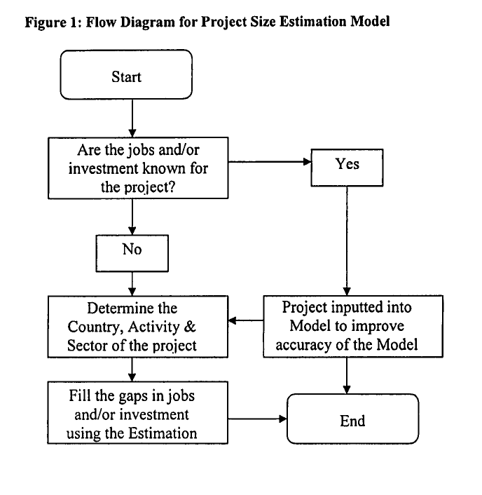

FIGS. 1 to 4 are flow charts for illustrating operation according to an embodiment of the present invention;

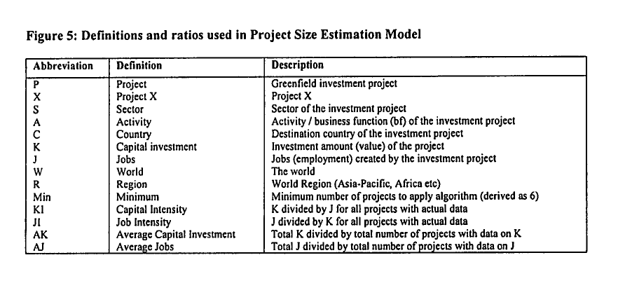

FIG. 5 shows the definitions and ratios used in the Project Size Estimation algorithm;

FIG. 6 shows the Project Classification System used in the Project Size Estimation algorithm;

FIG. 7 shows the Standard Database Structure used to classify Location Criteria and Location Factor in the Triple Weighted Location Assessment Model;

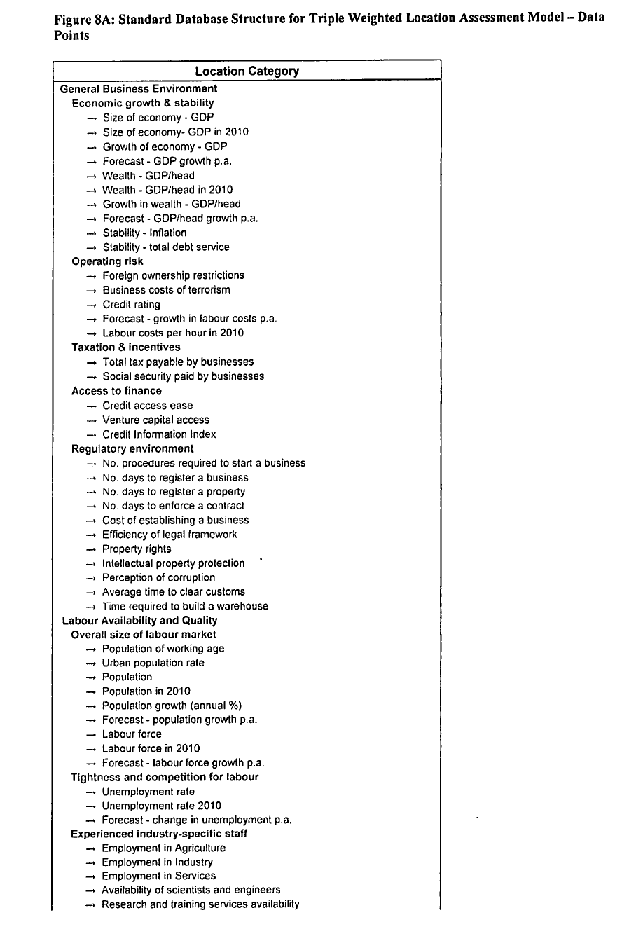

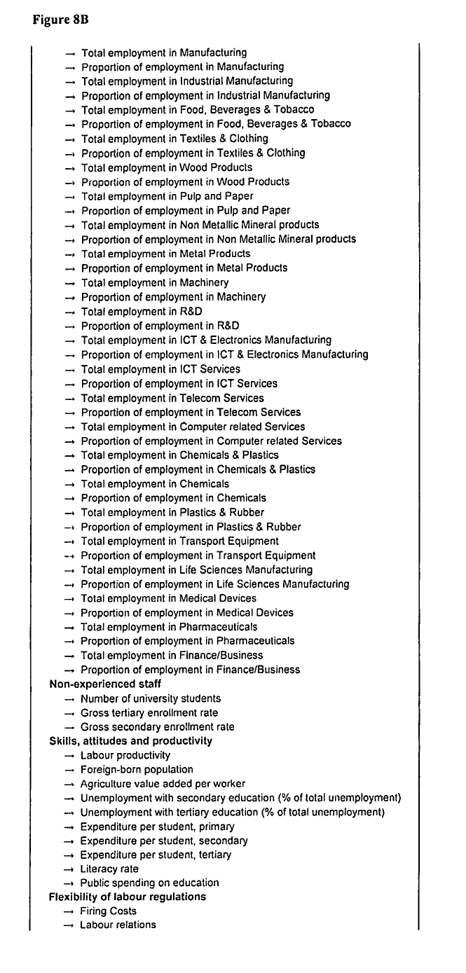

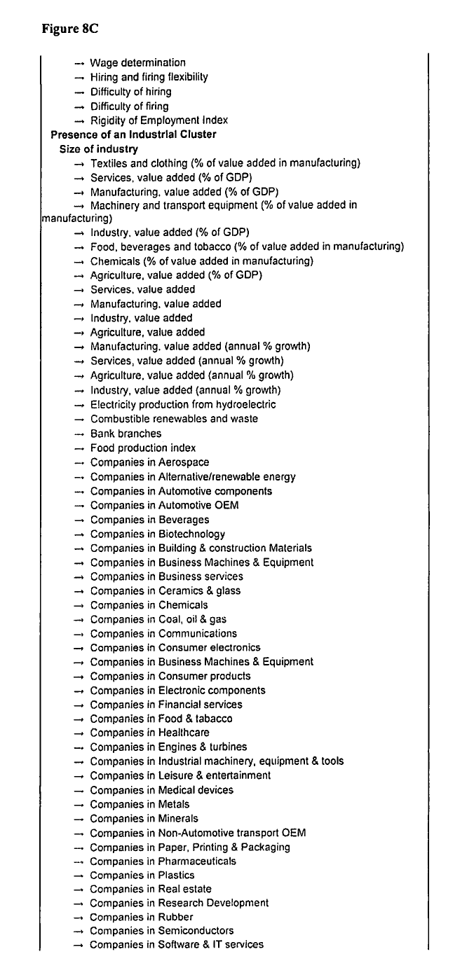

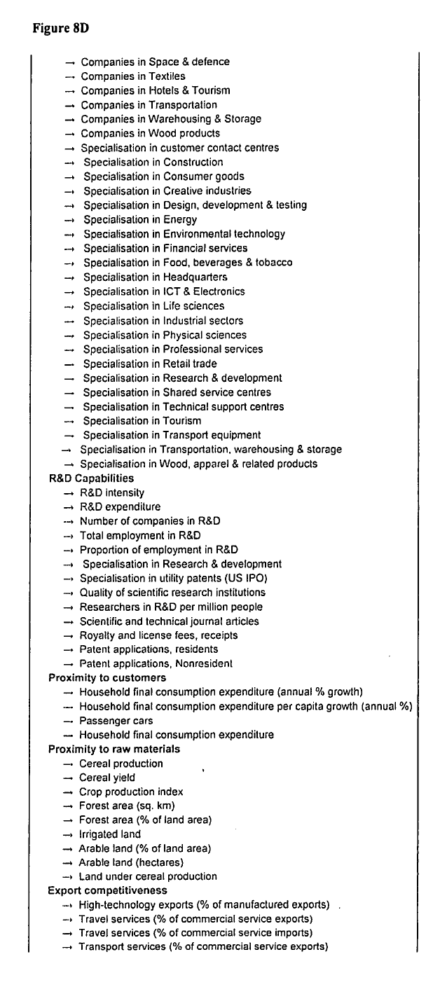

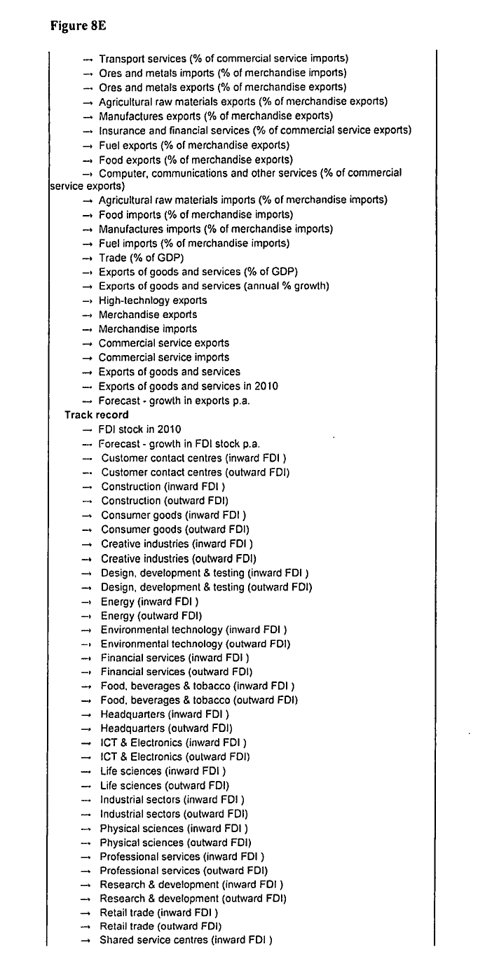

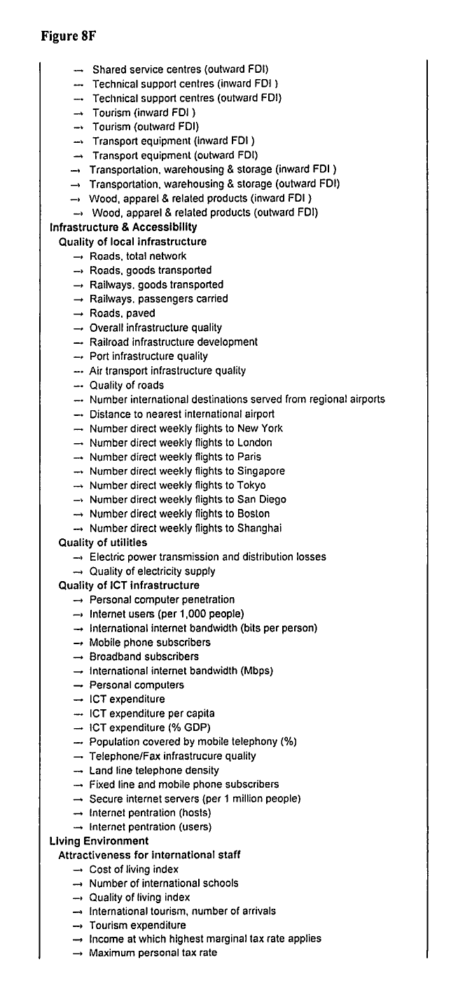

FIGS. 8A to 8G shows the Standard Database Structure used to classify Data Points in the Triple Weighted Location Assessment Model;

FIG. 9 shows the Weighting Model, with the three tiers of Weight used in the Triple Weighted Location Assessment Model;

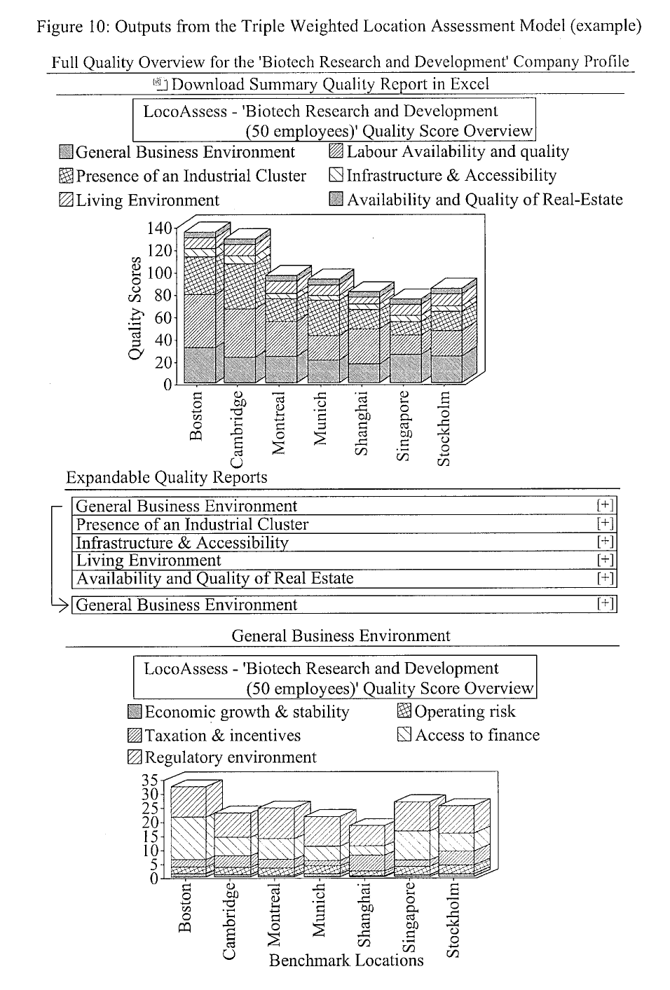

FIG. 10 shows key outputs generated by the Triple Weighted Location Assessment Model; and

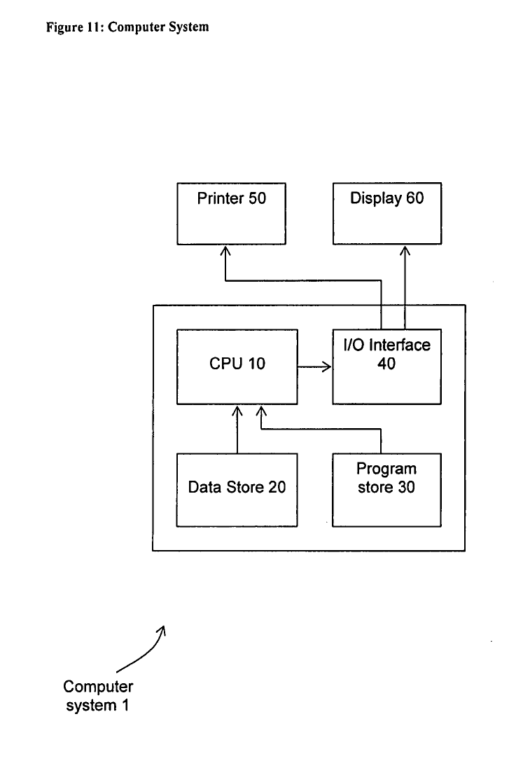

FIG. 11 is a schematic illustration of a computer system 1 in which a method embodying the present invention is implemented.

To determine the size of Greenfield investment projects the new invention relates to a Project Size Estimation Model, which comprises two main types of algorithm. The first algorithm, as set out below in paragraph [0030], calculates key ratios based on actual capital investment and employment data, and the second algorithm, as set out below in paragraph [0031], uses these ratios to estimate capital investment and employment data for all Greenfield investment projects where there are gaps in the data. The two types of algorithm are outlined in more detail below.

Research and statistical testing by the present applicant has identified 24 ratios considered desirable in a preferred embodiment to estimate capital investment and employment creation. The rationale behind the ratios is that to estimate capital investment and employment creation to the highest degree of accuracy it is necessary to apply different ratios for capital intensity, job intensity and average project size. Capital intensity ratios are applied when the jobs created by a project are known, but the capital investment is not known. Capital intensity is the amount of capital investment (in $) for each job created. Research has shown that capital intensity varies by the Sector and Activity of the project, and by the Country the project is locating in. Where there is insufficient historic data to calculate the capital intensity by Sector, Activity and Country, then different capital intensity ratios are applied. The inverse of capital intensity (job intensity) is applied using an identical method when the capital investment of a project is known but the employment creation is not known. In cases where neither investment nor jobs is known, then the average size of previous projects in a specific Sector, Activity and Country combination are used to make the estimate. Algorithms are used to calculate the ratios based on previous Greenfield investment projects where actual data on jobs and investment is available. It has been determined that it is preferable that at least 6 previous projects with actual data are used, in order to produce a reliable ratio. To calculate the average intensity ratios and project size ratios, the algorithm preferably removes the top and bottom 10% of ratios based (or the lowest and highest ratio in sample sizes with less than 10 projects), which is found to improve the accuracy of results. Twenty-four ratios are desirable due to gaps in historic data with actual jobs and investment data (there are 134,784 Country-Activity-Sector combinations, each of which the model attempts to calculate ratios for based on the historic data). As the algorithm cannot always calculate the most accurate ratios (the most accurate are KI CAS, JI CAS and AK CAS), the algorithm selects the most accurate ratio, for example through a software programme, to estimate the investment and/or jobs for a specific project. The 24 ratios that the algorithm calculates are listed below. Definitions are provided in FIG. 5 and the project classification system in FIG. 6.
1. Average capital intensity of projects in a given Country, Activity and Sector (KI CAS)
2. Average capital intensity of projects in a given Region, Activity and Sector (KI RAS)
3. Average capital intensity of projects in the World, Activity and Sector (KI WAS)
4. Average capital intensity of projects in a given Activity and Country (KI CA)
5. Average capital intensity of projects in a given Activity and Region (KI RA)
6. Average capital intensity of projects in the World and Activity (KI WA)
7. Average job intensity of projects in a given Country, Activity and Sector (JI CAS)
8. Average job intensity of projects in a given Region, Activity and Sector (JI RAS)
9. Average job intensity of projects in a the World, Activity and Sector (JI WAS)
10. Average job intensity of projects in a given Activity and Country (JI CA)
11. Average job intensity of projects in a given Activity and Region (JI RA)
12. Average job intensity of projects in the World and Activity (JI WA)
13. Average capital investment of projects in a given Country, Activity and Sector
(AK CAS)
14. Average capital investment of projects in a given Region, Activity and Sector (AK RAS)
15. Average capital investment of projects in the World, Activity and Sector (AK WAS)
16. Average capital investment of projects in a given Country and Activity (AK CA)
17. Average capital investment of projects in a given Region and Activity (AK RA)
18. Average capital investment of projects in the World and Activity (AK WA)
19. Average jobs of projects in a given Country, Activity and Sector (AJ CAS)
20. Average jobs of projects in a given Region, Activity and Sector (AJ RAS)
21. Average jobs of projects in the World, Activity and Sector (AJ WAS)
22. Average jobs of projects in a given Country and Activity (AJ CA)
23. Average jobs of projects in a given Region and Activity (AJ RA)
24. Average jobs of projects in the World and Activity (AJ WA)

The 24 ratios set out in paragraph [0030] are stored in a look-up table for the possible 134,784 different combinations, and are updated automatically by the software programme on a periodic basis as more historic data with actual investment and jobs data is available. The ratios are then applied to all Greenfield projects with gaps in capital investment and/or employment creation. One of three possible sets of algorithm are applied to an individual project, depending on whether there is a gap in capital investment, jobs or both:
Case type A: Gap in capital investment. The jobs created by a Greenfield investment project are known, while the capital investment is not known, and requires estimating. One of six algorithms is applied to calculate the estimate. Algorithm A1 is most accurate and A6 is least accurate. The algorithm applied depends on which ratios are available based on historic actual data. Note that “>Min” refers to minimum number of projects with actual data matching the condition needed for this condition to be accurate enough to be applied (see point 30 for the required minimum)

| | Condition (for calculating | Algorithm (for calculating |
|---|---|---|
| | capital investment) | capital investment) |
| A1 | >Min KI CAS | K = PX (J) × KI CAS |
| A2 | <Min KI CAS, >Min KI RAS | K = PX (J) × KI RAS |
| A3 | <Min KI RAS, >Min KI WAS | K = PX (J) × KI WAS |
| A4 | <Min KI WAS, >Min KI CA | K = PX (J) × KI CA |
| A5 | <Min KI WAS, <Min KI CA, >Min | K = PX (J) × KI RA |
| | KI RA | |
| A6 | <Min KI WAS, <Min KI CA, | K = PX (J) × KI WA |
| | <Min KI RA, >Min KI WA | |

Case type B: Gap in jobs (employment) created. The capital investment created by a Greenfield investment project is known, while the jobs created are not known, and requires estimating. One of six algorithms is applied to calculate the estimate. Algorithm B1 is most accurate and B6 is least accurate. The algorithm applied depends on which ratios are available based on historic actual data.

| | | Algorithm (for |
|---|---|---|
| | | calculating |
| | Condition (for calculating job creation) | job creation) |
| B1 | >Min JI CAS | J = PX (K) × JI CAS |
| B2 | <Min JI CAS, >Min JI RAS | J = PX (K) × JI RAS |
| B3 | <Min JI RAS, >Min JI WAS | J = PX (K) × JI WAS |
| B4 | <Min JI WAS, >Min JI CA | J = PX (K) × JI CA |
| B5 | <Min JI WAS, <Min JI CA, >Min JI RA | J = PX (K) × JI RA |
| B6 | <Min JI WAS, <Min JI CA, | J = PX (K) × JI WA |
| | <Min JI RA, >Min JI WA | |

Case type C: Gap in capital investment and jobs (employment) created. The capital investment and jobs created by a Greenfield investment project is not known, and both require estimating. One of six algorithms is applied to calculate the estimate for both capital investment and jobs. Algorithm C1 is most accurate and C6 is least accurate. The algorithm applied depends on which ratios are available based on historic actual data.

| | | Algorithm (for |
|---|---|---|
| | Condition | calculating |
| | (for calculating capital investment) | capital investment) |
| C1 (K) | >Min AK CAS | PX (K) = AK CAS |
| C2 (K) | <Min AK CAS, >Min AK RAS, <Min | PX (K) = AK RAS |
| | AK CA | |
| C3 (K) | <Min AK CAS, <Min AK RAS, >Min | PX (K) = AK WAS |
| | AK WAS, <Min AK RA | |
| C4 (K) | <Min AK WAS, >Min AK CA | PX (K) = AK CA |
| C5 (K) | <Min AK WAS, <Min AK CA, >Min | PX (K) = AK RA |
| | AK RA | |
| C6 (K) | <Min AK WAS, <Min AK RA, >Min | PX (K) = AK WA |
| | AK WA | |
| | | Algorithm |
| | | (for calculating |
| | Condition (for calculating job creation) | job creation) |
| C1 (J) | >Min AJ CAS | PX (J) = AJ CAS |
| C2 (J) | <Min AJ CAS, >Min AJ RAS, <Min | PX (J) = AJ RAS |
| | AJ CA | |
| C3 (J) | <Min AJ CAS, <Min AJ RAS, >Min AJ | PX (J) = AJ WAS |
| | WAS, <Min AJ RA | |
| C4 (J) | <Min AJ WAS, >Min AJ CA | PX (J) = AJ CA |
| C5 (J) | <Min AJ WAS, <Min AJ CA, >Min | PX (J) = AJ RA |
| | AJ RA | |
| C6 (J) | <Min AJ WAS, <Min AJ RA, >Min | PX (J) = AJ WA |
| | AJ WA | |

The Ratios in paragraph [0030] and Algorithms in paragraphs [0032] to [0034] are sufficient to estimate capital investment and employment creation for Greenfield investment projects worldwide, across all sectors and countries. The present applicant has completed this for all Greenfield Foreign Direct Investment projects. When the Project Size Estimation model is applied, the total estimated capital investment through Greenfield Foreign Direct Investment projects from 2003-2006 was US $3 trillion and employment creation 15 million new jobs. The Model is being applied constantly, through a software programme, to all Greenfield Foreign Direct Projects and to all Inter-State Greenfield Investment Projects in the U.S. as they are announced real time.

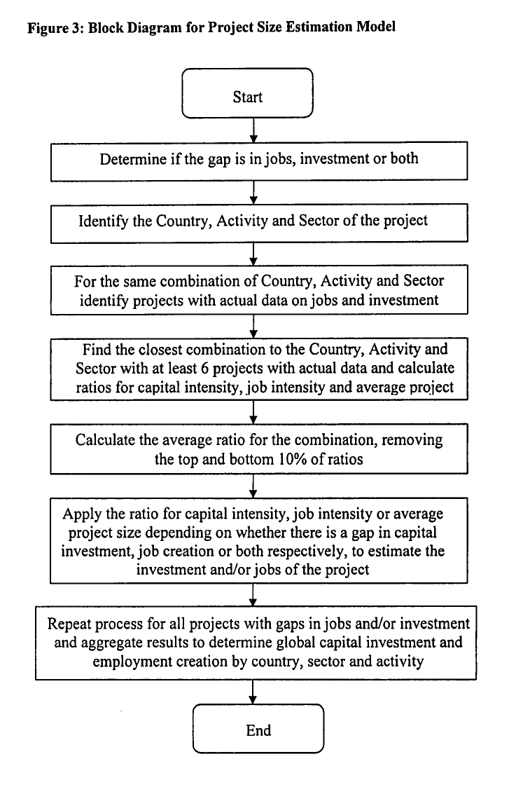

An embodiment of the above-described aspect of the present invention is illustrated schematically in FIGS. 1 and 3.

To determine the optimal geographic location for a Greenfield investment project in terms of the highest quality location for the investment project, the new invention relates to a Triple Weighted Location Assessment Model. The Model in a preferred embodiment comprises four unique elements:
Standard Database Structure, shown in FIG. 7 and FIG. 8. The Database Structure provides a structured, coherent classification system for the Triple Weighted Location Assessment Model, which can be used across all types of Greenfield investment project. The Database is used for storing the location data in a structured format, which feeds into the Triple Weighted Location Assessment Model to calculate the competitiveness of locations for specific Greenfield investment projects. The database structure is organized into six main Location Criterion, sub-divided into 32 Location Factors. The Location Criteria reflect the overall location determinants of Greenfield Investment projects, while the more specific Location Factors reflect the individual factors determining investment location for different types of Greenfield project. This database structure for Location Criterion and Location Factors is shown in FIG. 7. Each Location Factor is subdivided in individual Data-Points. A Data-Point is the actual unit data that is collected on locations. The present applicant has identified the Data-Points that can be used to assess location competitiveness for over 30 different sectors. The Data-Points are shown in FIG. 8, categorized by Location Criteria and Location Factor. To build the database structure and identify the Location Criteria, Location Factors and Data-Points required research to identify the location determinants for over 5,000 actual Greenfield investment projects. Further research served to collect the data on 60 Countries and 200 Cities worldwide for all the Data Points in FIG. 8, which will feed into the Triple Weighted Location Assessment Model, used for example in an online location benchmarking tool (www.ocoassess.com).
Triple Weighted Model, shown in FIG. 9. The Triple Weighted Model applies three sets of “weight” which are used to calculate the competitiveness of locations. The first step is to select the Location Criteria, Location Factors and individual Data-Points most important to assess locations for a specific Greenfield investment project. The Location Criteria, Factors and Data Points are selected from the Standard Database, see paragraph [0037] above. Note that Data-Points used by the model depend on the Greenfield investment project and in particular the Sector and Activity of the project. Additional or different Data-Points to those indicated in FIG. 8 may also be used.
The example in FIG. 9 shows a Biotechnology Research & Development investment project. Under the Location Criteria “Availability of Labour and Quality” and the Location Factor “Availability of industry-specific” staff are individual Data-Points for number of people employed in life sciences and R&D. If instead the investment project was for Automotive Manufacturing, as an example, then the respective Data-Points would be for number of people employed in automotive-related activities.
Each Criteria, Factor and Data-Point is given a weight (hence, the model is Triple Weighted), based on their importance in the investment decision. In the preferred embodiment, the sum of Location Criteria weights always adds up to 100, the sum of Location Factor weights always adds up to 100 and the sum of Data-Point weights always adds up to 100. By adjusting the weights, the Model can be customized for all types of Greenfield Investment Project.
Quality Assessment Algorithms are applied to the Triple Weighted Model, which a software programme developed by the present applicant runs when data has been collected for all the Data-Points. The Quality Assessment Algorithm is shown below. The algorithms are designed so that data on locations can be compared and evaluated through a purely quantitative approach to determine the quality of locations for specific Greenfield investment projects.

| Step | Description | Algorithm |
|---|---|---|
| Q1 | Calculate the “Average Value” | Average Value of Data-Point (X) = Sum of values for Data-Point (X) for each Location |
| | of each “Data-Point” | divided by the total numbers of Locations. Repeat for all Data-Points. |
| Q2 | Calculate the “Location | Deviation of Location (A) for Data Point (X) = Value of Data-Point (X) for Location (A) |
| | Deviation” of each Location for | divided by the Average Value of Data-Point (X) for all Locations. Note that where a high |
| | each Data-Point | value fur a Data-Point is “bad” i.e. has a negative impact on Location Quality then the |
| | | deviation from the average is inversed. Repeat for all Locations and Data-Points. |
| Q3 | Calculate the “Weighted Score” | Weighted Score of Location (A) for Data point (X) = Deviation of Location (A) for Data |
| | of each Location for each Data- | Point (X) multiplied by the Weight given to Data Point (X). Repeat for all Locations and |
| | Point | Data points. |
| Q4 | Calculate the Weighted Score of | Weighted Score of Location (A) for Location Factor (Y) = Sum of Weighted Scores for all |
| | each Location for each | Data-Points included in Location Factor (Y) for Location (A) multiplied by the Weight |
| | “Location Factor” | given to Location Factor (Y). Repeat for all Locations and Location Factors. |
| Q5 | Calculate the Weighted Score of | Weighted Score of Location (A) for Location Criteria (Z) = Sum of Weighted Scores for all |
| | each Location for each | Location Factors included in Location Criteria (Z) for Location (A) multiplied by the |
| | “Location Criteria” | Weight given to Location Criteria (Z). Repeat for all Locations and Location Criteria. |
| Q6 | Calculate the “Quality | Quality Competitiveness Score of Location (A) = Sum of Weighted Location Criteria |
| | Competitiveness Score” of each | Scores for Location (A). Repeat for all Locations |
| | Location | |

An example output from the Triple Weighted Location Assessment Model are shown in FIG. 10. The first key output is a Graph showing the total Quality Competitiveness of each location, with a breakdown by Location Criteria. A key feature of the Triple Weighted Location Assessment Model in this embodiment is that the algorithms are designed so that the average Quality Competitiveness Score of each location being benchmarked is always exactly 100. The actual Quality Competitiveness Score of each location therefore shows the deviation from the average of all locations, facilitating clear and precise interpretation of the results. In FIG. 10, it is therefore accurate to say that Boston has nearly 40% higher quality on average than other leading locations for Greenfield investment projects in Biotechnology Research & Development. The results can be further disaggregated, with the (Weighted) Quality Scores being shown by Location Factors within each category of Location Criteria (see FIG. 9 for an example).

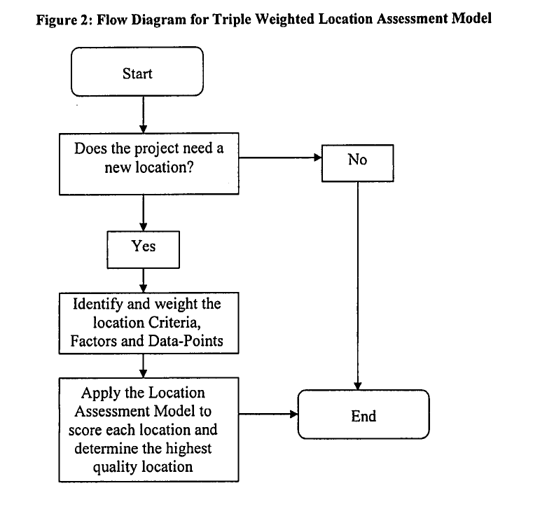

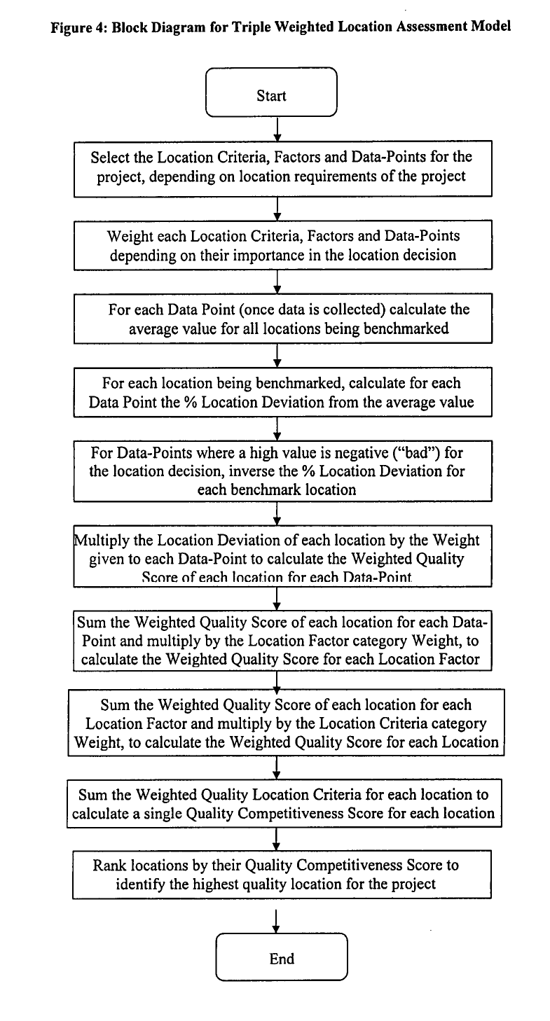

An embodiment of the above-described second aspect of the present invention is illustrated schematically in FIGS. 2 and 4.

FIG. 11 is a schematic illustration of a computer system 1 in which a method embodying the present invention is implemented. A computer program for controlling the computer system 1 to carry out a method embodying the present invention is stored in a program store 30. Data used during the performance of a method embodying the present invention is stored in a data store 20. During performance of a method embodying the present invention, program steps are fetched from the program store 30 and executed by a Central Processing Unit (CPU), retrieving data as required from the data store 20. Output information resulting from performance of a method embodying the present invention is sent to an Input/Output (I/O) interface 40, which directs the information to a printer 50 and/or a display 60, as required.

It will be appreciated that modifications can be made to the examples described above within the scope of the appended claims.

What is claimed is:

1. A method of estimating the size of a Greenfield investment project, where size is at least one of capital investment and employment creation, comprising accessing data from a Project Size Estimation model database which specifies a set of ratios relating to historical capital investment intensities, job creation intensities and project size for each of a plurality of combinations of Country, Activity and Sector, and using the data to estimate the size of the Greenfield investment project.

2. A method as claimed in claim 1, comprising outputting the estimated size.

3. A method as claimed in claim 2, wherein outputting comprises at least one of displaying and printing.

4. A method as claimed in claim 1, wherein ratios for capital investment intensities, job intensities, capital investment and job creation are specified in the database for each combination of Country, Activity and Sector.

5. A method as claimed in claim 1, wherein the ratios are determined subject to minimum sample size requirements and adjustments to remove outliers.

6. A method of estimating the highest quality geographic location for a Greenfield investment project, comprising accessing data from a Weighted Location Assessment Model database which specifies a plurality of weights associated with respective influence items arranged in three predetermined tiers: (1) a set of Location Criteria; (2) a set of Location Factors within each Location Criterion; and (3) a set of Data Points within each Location Criterion; each weight indicating the relative importance of its associated influence item in investment decision making, and using the data to calculate an overall Quality Competitiveness of various locations for the Greenfield investment project for use in estimating the highest quality location for the Greenfield investment project.

7. A method as claimed in claim 6, comprising presenting the results in graphical form.

8. A method as claimed in claim 6, wherein the calculation is based on a model that considers how each location deviates from the average of all locations.

9. A method as claimed in claim 6, wherein the weights in each set sum to a predetermined number.

10. A method as claimed in claim 6, wherein the average Quality Competitiveness of all locations is arranged to be a predetermined number.

11. A method as claimed in claim 9, wherein the predetermined number is 100.

12. A method as claimed in claim 6, wherein the results show, for each location, the overall Quality Competitiveness with a breakdown by Location Criteria.

13. A method as claimed in claim 6, wherein the results show, for each location, a breakdown for at least one Location Factor.

14. A method as claimed in claim 6, comprising calculating the deviation from the average of all locations for each Data Point.

15. A method as claimed in claim 14, comprising multiplying the deviation from the average by the weights assigned to each Data Point to produce a Weighted Quality Score of each Location for each Data Point.

16. A method as claimed in claim 15, comprising multiplying the sum of weighted quality scores for all Data Points within each Location Factor by the weights assigned to each Location Factor to produce a Weighted Quality Score of each Location for each Location Factor.

17. A method as claimed in claim 15, comprising multiplying the sum of weighted quality scores for all Location Factors within each Location Criteria by the weights assigned to each Location Criteria to produce a Weighted Quality Score of each Location for each Location Criteria.

18. A method as claimed in claim 15, wherein the sum of weighted quality scores for each location criteria produces a single Quality Competitiveness Score for each location.

19. A method as claimed in claim 18, wherein the score is 100% aligned to the location requirements of the Greenfield investment project, and calculated quantitatively based on empirical data (Data Points).

20. A program stored on a machine readable medium which, when executed, causes the machine to perform the method recited in claim 1.

21. A program stored on a machine readable medium which, when executed, causes the machine to perform the method recited in claim 6.
